(19) United States
(12) Patent Application Publication
(10) Pub. No.: US 2006/0070798 A1
(43) Pub. Date: Apr. 6, 2006

(54) Training system for assisting a child with learning bipedal motion

(76) Inventors: Greg DiCristina, Temecula, CA (US); Karolin DiCristina, Temecula, CA (US)

Correspondence Address: Greg DiCristina, 32863 Levi Court, Temecula, CA, 92592-1482, US

(21) Appl. No.: 10/951,205

(22) Filed: Sep. 27, 2004

(51) Int. Cl. A62B 35/00

(52) U.S. Cl. 182/3

(57) ABSTRACT

A system is provided for developing bipedal motor skill of a child. The system comprises a padded belt that is secured about the child's upper torso under the arms. The padded belt comprises first and second fastening straps at respective first and second distally opposite ends of the padded belt that are used to secure the padded belt about the child's torso. The fastening straps have fastening means attached to the straps that couple the two straps together as a belt about the child's torso. The system also includes a pair of handle straps coupled to the padded belt. The two handle straps are configured for being held by an assistant to support the child during bipedal motion. When the handle straps are held with one in each hand, the assistant can support the child from the straps so that the child may walk without risk of falling.

### BACKGROUND OF THE INVENTION

1. Field of the Invention

The invention relates generally to developing bipedal motor skills of a child. More specifically, the invention relates to a belt system that allows an assistant to support the child in a manner that encourages walking while reducing physical stress to the assistant.

2. Discussion of the Related Art

Many devices exist for assisting a child in the development of bipedal motor skills. For example, some devices are configured as harnesses that substantially envelope the child with a plurality of restraining straps. The devices are typically hand-held by an adult assistant (e.g., a parent) to support the child allowing the child's feet to come in contact with a walking surface. As the child's feet walk upon the surface with the support of the assistant, the child may improve its bipedal motor skills and ultimately learn to walk.

The prior art devices typically have a handle, or a strap, in which the assistant may grasp the device and support the child. Often, these devices comprised only a single grasping means which the assistant could use to suspend the child. Accordingly, these devices resulted in an awkward position for the assistant as the assistant was either forced to suspend the child with one hand or use two hands to hold the grasping means. This awkward position of the assistant tended to place physical stress upon the assistant, particularly in the assistant's lower back region. This physical stress creates fatigue in the assistant and typically shortens the duration in which the assistant may train the child in walking.

Additionally, the prior art devices were often complicated and therefore difficult to secure the child properly. The complicated nature of the prior art devices could also make the process of securing a child a time-consuming one that could potentially diminish the desire of the assistant to train the child. Moreover, prior art devices did not typically focus on the comfort of the child. Any substantial lack of comfort in the child, as is well-known to those skilled in the art, could result in altering the temperament of the child and thereby reduce the amount of time that an assistant may train the child. For at least these reasons, it is a continuing goal to improve such bipedal motor skill trainers.

### SUMMARY OF THE INVENTION

In one embodiment of the invention, a system is provided for developing bipedal motor skill of a child. The system comprises a padded belt that is secured about the child's upper torso under the arms. The padded belt comprises first and second fastening straps at respective first and second distally opposite ends of the padded belt that are used to secure the padded belt about the child's torso. For example, the fastening straps have fastening means attached to the straps that couple the two straps together as a belt about the child's torso.

The system also includes a pair of handle straps coupled to the padded belt. The two handle straps are configured for being held by an assistant (e.g., an adult) to support the child during bipedal motion. For example, when the handle straps are held with one in each hand, the assistant can support the child from the straps so that the child may walk upon a surface without substantial risk of falling. Since the straps are held in each hand of the assistant, the child is supported in a manner that is centric to the assistant (i.e., between the assistant's feet). This type of support reduces the physical stress placed on the assistant and may, therefore, allow the assistant to operate the system for greater periods of time. As such, the child may benefit from the system by spending more time developing bipedal motor skills.

In one embodiment of the invention, a system for developing bipedal motor skill of a child comprises: a padded belt configured for securing about the child's torso under the arms, wherein the padded belt comprises first and second fastening straps at respective first and second distally opposite ends of the padded belt; a first fastener attached to the first fastening strap; a second fastener attached to the second fastening strap and configured for coupling with the first fastener to secure the padded belt about the child's torso; a first handle strap coupled to the padded belt; and a second handle strap coupled to the padded belt, wherein the first and the second handle straps are configured for being held by an assistant to support the child during bipedal motion while reducing physical stress to the assistant.

In another embodiment of the invention, the padded belt comprises a padded member, detachable or integral, contained within the padded belt.

In another embodiment of the invention, the first and the second fasteners are movably attached to the respective first and second ends of the padded belt.

In another embodiment of the invention, the first and the second fasteners are interconnecting buckle fasteners.

In another embodiment of the invention, the first and the second fasteners are hook and loop fasteners.

In another embodiment of the invention, the padded belt comprises a first coupling loop and a second coupling loop configured for respectively coupling the first handle strap and the second handle strap to the padded belt.

In another embodiment of the invention, the first coupling loop is a D-ring.

In another embodiment of the invention, the first handle strap is adjustably coupled through the first coupling loop and secured with hook and loop fasteners.

In another embodiment of the invention, the first handle strap is coupled to the coupling loop with a clip fastener.

In another embodiment of the invention, the system further comprises a buckle movably attached to the first handle strap and configured for creating a handle for the handle strap that is adjustable through the moveable attachment of the buckle.

In one embodiment of the invention, a bipedal development system comprises: a belt configured for securing about the child's torso under the arms; a first fastener attached to a first end of the belt; a second fastener attached to a second end of the belt and configured for coupling to the first fastener to secure the belt about the child's torso; a first handle strap coupled to the belt; and a second handle strap coupled to the belt, wherein the first and the second handle straps are retainable by an assistant to support the child during bipedal motion while reducing physical stress to the assistant.

In another embodiment of the invention, the belt comprises a first D-ring and a second D-ring configured for respectively coupling the first handle strap and the second handle strap to the padded belt.

In another embodiment of the invention, the first handle strap is adjustably coupled through the first D-ring and secured with hook and loop fasteners.

In another embodiment of the invention, the first handle strap is coupled to the first D-ring with a clip fastener.

In another embodiment of the invention, the system further comprises a buckle movably attached to the first handle strap and configured for creating a handle for the handle strap that is adjustable through the moveable attachment of the buckle.

In one embodiment of the invention, a system for developing bipedal motor skill of a child comprises: means for securing a belt about the child's upper torso under the arms; means for coupling first and second handle straps to the belt; means for adjusting the length of the first and the second handle straps to a length that reduces physical stress to an assistant; and means for holding the first and the second handle straps by hand, wherein the means for holding, when held by the assistant, supports the child during walking.

In one embodiment of the invention, a system for developing bipedal motor skill of a child comprises: a padded belt configured for securing about the child's torso under the arms, wherein the padded belt comprises first and second fastening straps at respective first and second distally opposite ends of the padded belt and wherein the padded belt comprises a pad formed of a cloth like material folded over upon itself a plurality of times and sewn together to provide padding; a hook fastener attached to the first fastening strap; a loop fastener attached to the second fastening strap and configured for coupling with the hook fastener to secure the padded belt about the child's torso; a first handle strap coupled to the padded belt via a first coupling loop attached to the padded belt, wherein the first handle strap comprises a hook and loop fastener configured for coupling the first handle strap to the first coupling loop; and a second handle strap coupled to the padded belt via a second coupling loop attached to the padded belt, wherein the second handle strap comprises a hook and loop fastener configured for coupling the second handle strap to the second coupling loop, and wherein the first and the second handle straps are configured for being held by an assistant to support the child during bipedal motion while reducing physical stress to the assistant.

### BRIEF DESCRIPTION OF THE DRAWINGS

FIGS. 1a and 1b are profile and top views of a padded belt with fastening straps and coupling loops in one exemplary embodiment of the invention.

FIGS. 2a and 2b illustrate two exemplary embodiments of handle straps.

FIG. 3 illustrates a buckle attached to a fastening strap in one embodiment of the invention.

FIG. 4 illustrates a buckle in one exemplary embodiment of the invention.

FIG. 5 illustrates an interconnecting fastener for coupling a pair of fastening straps together, in one exemplary embodiment of the invention.

FIG. 6 illustrates an exemplary use of a system for developing bipedal motor skill of a child in one exemplary embodiment of the invention.

### DETAILED DESCRIPTION OF THE DRAWINGS

While the invention is susceptible to various modifications and alternative forms, a specific embodiment thereof has been shown by way of example in the drawings and will herein be described in detail. Those skilled in the art will appreciate that the features described below can be combined in various ways to form multiple variations of the invention. Accordingly, the invention is not limited to the specific examples described below, but only by the claims and their equivalents.

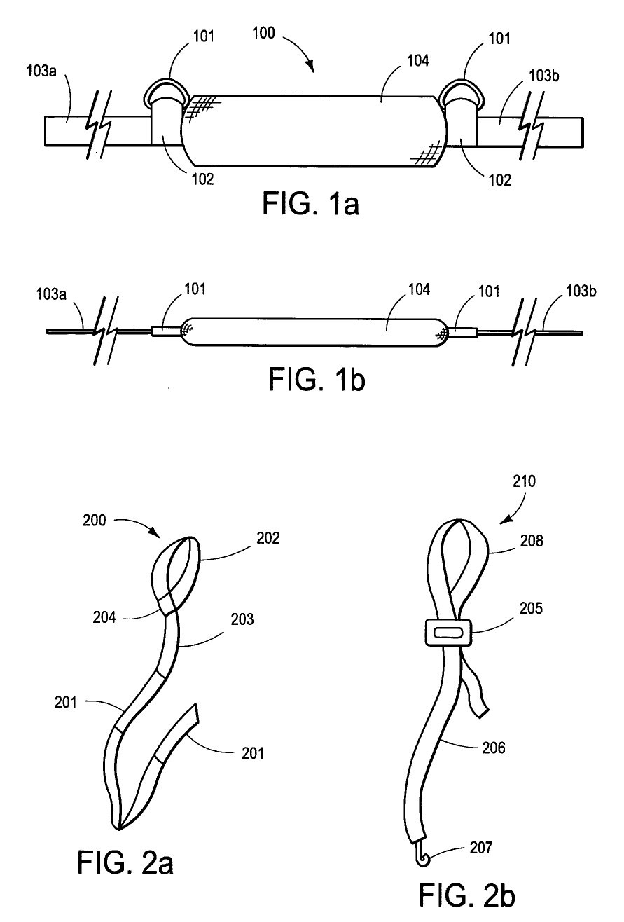

With reference now to FIGS. 1a and 1b, FIGS. 1a and 1b are respectively profile and top views of padded belt 100 with fastening straps 103a and 103b and coupling loops 101, in one exemplary embodiment of the invention. When configured with a handling apparatus (e.g., handle straps 200 and 210 of respective FIGS. 2a and 2b) padded belt 100 forms a system for developing bipedal motor skills of a child.

Padded belt 100 is configured for securing about a child's torso under the arms. Padded belt 100 comprises fastening straps 103a and 103b at respective distally opposite ends of the padded belt. For example, padded belt 100 may be formed of a cloth like material, such as a nylon cloth used in the backpacking industry, with a pad 104, such as the foam pad of a backpack belt, sewn therein. In a preferred embodiment, padded belt 100 may be alternatively formed of a cloth like material that is folded over upon itself a number of times to provide a desired padding thickness. For example, a soft material may be folded upon itself more than once and then sewn together to maintain the integrity of the folds. The pad 104, therefore, develops as a result of the multiple layers of soft material held together through the sewn attachment.

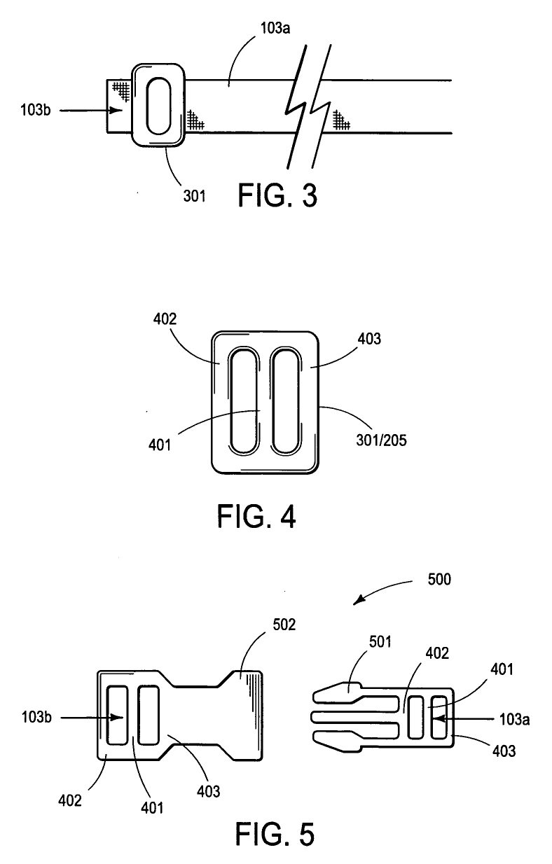

Fastening straps 103a and 103b may comprise a similar material with a higher denier than the cloth surrounding and/or forming pad 104 and sewn to the ends of the padded belt 100. Fastening straps 103a and 103b are configured for securing padded belt 100 about the child's torso in a snug yet comfortable fashion. Fastening straps 103a and 103b may be coupled together with coupling devices attached to the fastening straps to secure padded belt 100. In one embodiment, fasteners or buckling devices, such as those described herein below in FIGS. 3, 4 and 5, are movably attached to the fastening straps 103a and 103b for securing padded belt 100. In another embodiment, the fastening straps may have a hook and loop type fastening system, such as that produced by Velcro Industries B.V., affixed to fastening straps 103a and 103b.

Coupling loops 101 are also configured with the padded belt 100. In a preferred embodiment, the coupling loops 101 are “D-rings” namely because of their shape. First and second coupling loops 101 are respectively attached to fastening straps 103a and 103b adjacent to pad 104. In a preferred embodiment, coupling loop straps 102 are constructed of a material similar to fastening straps 103a and 103b and sewn to the fastening straps. The attachment of the coupling loops 101 may be achieved with straps 102 that retain the coupling loops by traversing each strap through a coupling loop and sewing both ends of the strap to the fastening strap. Through this sewn attachment to fastening straps 103a and 103b, straps 102 may thereby affix the coupling loops 101 to padded belt 100 such that a handle apparatus (e.g., handle straps 200 and 210) may be coupled thereto. Such an attachment may also provide stability of the handle apparatus coupled thereto as the fastening straps 103a and 103b may align closely to the child's body giving the fastening straps additional support for coupling loops 101 when the handle apparatus is coupled thereto.

FIGS. 2a and 2b illustrate two exemplary embodiments of handle straps (i.e., handle straps 200 and 210). In FIG. 2a, handle strap 200 is formed from a single strap 203 typically comprised of the same material used in the construction of fastening straps 103. A handle 202 is formed by looping the strap 203 and affixing it upon itself at attachment 204. For example, attachment 204 may be the result of sewing strap 203 upon itself in a position suitable that forms handle 202 for grasping handle strap 200 by hand.

Handle strap 200, in this embodiment, also comprises a hook and loop fastening system 201, such as that described above herein, configured for adjustably attaching strap 200 to padded belt 100 at coupling loops 101. At one end of strap 203, a first portion of the hook and loop fastening system 201 is affixed to the strap and fed through coupling loop 101. This first portion of hook and loop fastening system 201 affixes to a second portion of hook and loop fastening system 201. As the length of the first and second portions of hook and loop fastening system 201 may be variably affixed, the length of strap 203 may be adjusted to a position that is suitable for user. For example, the length of handle strap 200 may be adjusted to a position through coupling loop 101 via a hook and loop fastening system 201 that provides comfort to a user while supporting a child secured by padded belt 100.

In FIG. 2b, handle strap 210 is formed from a single strap 206 also typically comprised of the same material used in the construction of fastening straps 103. In this embodiment, a handle 208 is formed as one end of the strap 206 is woven through buckle 205 already movably attached to strap 206. For example, the buckle 205, such as that found in the backpacking industry, may be used to secure a handle strap 206 to itself and thereby form handle 208. While adjustable, those skilled in the art should readily recognize that such a buckle 205 may provide an attachment strong enough to support a child.

At another end of strap 206, a clipping mechanism 207 is securely affixed to the strap. For example, clipping mechanism 207 may comprise an anchor that is sewn to handle strap 206. Means for affixing such a clipping mechanism are well known to those skilled in the art. Clipping mechanism 207 may be used to secure handle strap 210 to a coupling loop 101 of padded belt 100. Once secured to padded belt 100, handle strap 210 may be used to support a child in a manner similar to handle strap 200.

While two embodiments of a handle strap are shown and described, those skilled in the art should readily recognize that other means for handling padded belt 100 may be used and that such alternative implementations are a matter of design choice. For example, a handle may be configured through a sewn attachment of one end of strap 203 upon itself. A movable attachment may then be configured at the other end of strap 203 using a buckle, such as buckle 205 of handle strap 210. Accordingly, the invention should not be limited to the preferred embodiments shown and described herein. Rather, the invention should only be limited to the language recited in the claims and their equivalents.

FIG. 3 illustrates buckle 301 attached to a fastening strap in one exemplary embodiment of the invention. In this embodiment, buckle 301 is movably attached to a fastening strap 103a. Buckle 301 may adjustably secure padded belt 100 about a child's torso. For example, buckle 301 may be movably attached to fastening strap 103a with the other fastening strap 103b woven about buckle 301 on top of strap 103a. While one embodiment of fastening two straps together is shown and described herein, those skilled in the art should readily recognize that other means of fastening may be used as a matter of design choice. For example, fastening straps 103a and 103b may be attached using a hook and loop fastening system as described hereinabove. Accordingly, the invention is not intended to be limited to the exemplary embodiment shown and described herein Rather, he mentions it only be limited to language reset in the claims and their equivalents.

Those skilled in the art are familiar with such buckles and their movable attachments. Those skilled in the art should also readily recognize that the manner in which the buckle 301 is movably attached to a fastening strap is a matter of preference. For example, buckle 301 may be just as easily attached to fastening strap 103b with fastening strap 103a woven through buckle 301 on top of fastening strap 103b.

FIG. 4 illustrates buckle 301/205 in one exemplary embodiment of the invention. In this embodiment, buckle 301/205 (i.e., buckle 301 as illustrated in FIG. 3 and buckle 205 as illustrated in FIG. 2b) is a three bar restraint type of buckle as used in the backpacking industry. For example, a strap may be woven under bar 402, over bar 401 and under bar 403 providing a secure means for affixing a backpack waist belt about a person's torso. Accordingly, such a buckle 301/205 may be used to secure padded belt 100 with fastening straps 103a and 103b about a child's torso. Those skilled in the art are familiar with such buckles and means of fastening.

FIG. 5 illustrates interconnecting fastener 500 for coupling fastening straps 103a and 103b together, in one exemplary embodiment of the invention. Interconnecting fastener 500 comprises insert element 501 and clutching element 502. Each of elements 501 and 502 comprise a three bar restraint type buckle having bars 401 402 and 403 as described in FIG. 4. One fastening strap (e.g., fastening strap 103b is woven about the three bar buckle of clutching element 502 in such a way as to secure the buckle to the fastening strap as is known to those skilled in the art. The second fastening strap (e.g., fastening strap 103a) is similarly woven through the three bar buckle of insert element 501. The two elements 501 and 502 may couple the fastening straps together by inserting element 501 into element 502. Such an interconnecting fastener 500 is well-known to those skilled in the art. However, the invention is not intended to be limited to the embodiment shown and described herein. Other types of fastening devices may be used.

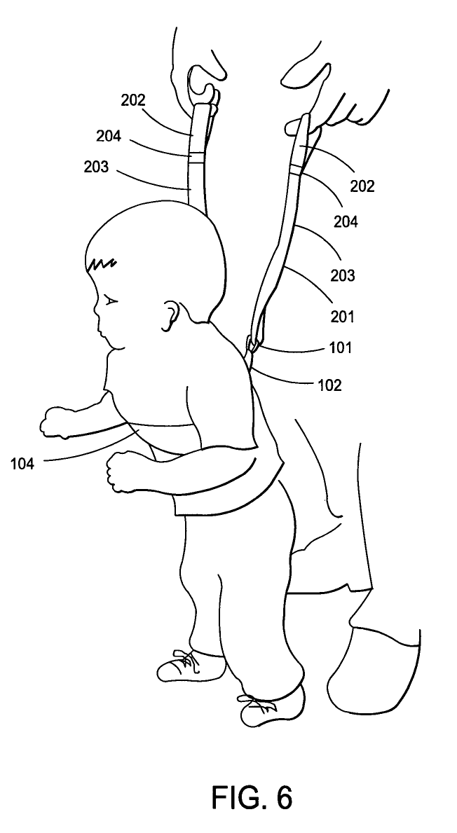

FIG. 6 illustrates an exemplary use of a system for developing bipedal motor skill of a child in one exemplary embodiment of the invention. In this embodiment, a child is supported by an assistant using padded belt 100 as shown and described in FIG. 1 physically coupled to handle straps. The handle straps of the preferred embodiment are handle straps 200 of FIG. 2a. Handle straps 200 are adjusted such that the assistant may support the child centric to the assistant's body. For example, the assistant may grasp a handle strap 200 (i.e., one handle strap 200 per hand) such that the child is centered about the assistant's body.

Handle straps 200 may be adjusted to length that is comfortable for the assistant. For example, the length of handle strap 200 may be adjusted by the positioning of the hook and loop fastening system 201. The length of handle straps 200, in the preferred embodiment, should be such that it allows the assistant to stand substantially upright thereby relieving physical stress and physical exertion upon the assistant particularly in the lower back region while supporting the child (i.e., allowing the child's feet to contact the walking surface).

As stress and physical exertion upon the assistant are reduced, fatigue in the assistant may also be reduced. The system may therefore allow the assistant to support the child for a longer period of time than the devices of the prior art. As the child may be assisted for a longer period of time, the child's bipedal motor skills may improve more rapidly. Additionally, as the assistant may no longer need to focus on his or her physical well-being during training, the assistant may concentrate more on supporting the child and thereby provide a substantially safe environment for the child when learning such bipedal motor skills.

While the invention has been illustrated and described in the drawings and foregoing description, such illustration and description is to be considered as exemplary and not restrictive in character. One embodiment of the invention and minor variants thereof have been shown and described. Those skilled in the art will appreciate variations of the above-described embodiments that fall within the scope of the invention. Protection is desired for all changes and modifications that come within the scope and spirit of the invention. Accordingly, the invention is not limited to the specific examples and illustrations discussed above, but only by the following claims and their equivalents.

What is claimed is:

1. A system for developing bipedal motor skill of a child, comprising:
a padded belt configured for securing about the child's torso under the arms, wherein the padded belt comprises first and second fastening straps at respective first and second distally opposite ends of the padded belt;
a first fastener attached to the first fastening strap;
a second fastener attached to the second fastening strap and configured for coupling with the first fastener to secure the padded belt about the child's torso;
a first handle strap coupled to the padded belt; and
a second handle strap coupled to the padded belt, wherein the first and the second handle straps are configured for being held by an assistant to support the child during bipedal motion while reducing physical stress to the assistant.

2. The system of claim 1, wherein the padded belt comprises a padded member, detachable or integral, contained within the padded belt.

3. The system of claim 1, wherein the first and the second fasteners are movably attached to the respective first and second ends of the padded belt.

4. The system of claim 3, wherein the first and the second fasteners are interconnecting buckle fasteners.

5. The system of claim 1, wherein the first and the second fasteners are hook and loop fasteners.

6. The system of claim 1, wherein the padded belt comprises a first coupling loop and a second coupling loop configured for respectively coupling the first handle strap and the second handle strap to the padded belt.

7. The system of claim 6, wherein the first coupling loop is a D-ring.

8. The system of claim 6, wherein the first handle strap is adjustably coupled through the first coupling loop and secured with hook and loop fasteners.

9. The system of claim 6, wherein the first handle strap is coupled to the coupling loop with a clip fastener.

10. The system of claim 8, further comprising a buckle movably attached to the first handle strap and configured for creating a handle for the handle strap that is adjustable through the moveable attachment of the buckle.

11. A bipedal development system, comprising:
a belt configured for securing about the child's torso under the arms;
a first fastener attached to a first end of the belt;
a second fastener attached to a second end of the belt and configured for coupling to the first fastener to secure the belt about the child's torso;
a first handle strap coupled to the belt; and
a second handle strap coupled to the belt, wherein the first and the second handle straps are retainable by an assistant to support the child during bipedal motion while reducing physical stress to the assistant.

12. The system of claim 1, wherein the belt comprises a first D-ring and a second D-ring configured for respectively coupling the first handle strap and the second handle strap to the padded belt.

13. The system of claim 12, wherein the first handle strap is adjustably coupled through the first D-ring and secured with hook and loop fasteners.

14. The system of claim 12, wherein the first handle strap is coupled to the first D-ring with a clip fastener.

15. The system of claim 14, further comprising a buckle movably attached to the first handle strap and configured for creating a handle for the handle strap that is adjustable through the moveable attachment of the buckle.

16. A system for developing bipedal motor skill of a child, comprising:
means for securing a belt about the child's upper torso under the arms;
means for coupling first and second handle straps to the belt;
means for adjusting the length of the first and the second handle straps to a length that reduces physical stress to an assistant; and
means for holding the first and the second handle straps by hand, wherein the means for holding, when held by the assistant, supports the child during walking.

17. A system for developing bipedal motor skill of a child, comprising:
a padded belt configured for securing about the child's torso under the arms, wherein the padded belt comprises first and second fastening straps at respective first and second distally opposite ends of the padded belt and wherein the padded belt comprises a pad formed of a cloth like material folded over upon itself a plurality of times and sewn together to provide padding;
a hook fastener attached to the first fastening strap;
a loop fastener attached to the second fastening strap and configured for coupling with the hook fastener to secure the padded belt about the child's torso;
a first handle strap coupled to the padded belt via a first coupling loop attached to the padded belt, wherein the first handle strap comprises a hook and loop fastener configured for coupling the first handle strap to the first coupling loop; and
a second handle strap coupled to the padded belt via a second coupling loop attached to the padded belt, wherein the second handle strap comprises a hook and loop fastener configured for coupling the second handle strap to the second coupling loop, and wherein the first and the second handle straps are configured for being held by an assistant to support the child during bipedal motion while reducing physical stress to the assistant.
